(19) United States
(12) Patent Application Publication
(10) Pub. No.: US 2023/0026478 A1
(43) Pub. Date: Jan. 26, 2023

(54) SCISSOR LIFT PLATFORM AND METHOD FOR DETERMINING THE STABILITY OF SUCH A PLATFORM

(71) Applicant: HAULOTTE GROUP, LORETTE (FR)

(72) Inventors: Slaheddine BEJI, VIENNE (FR); Joël MARET-VERDANT, SAINT PAUL EN JAREZ (FR)

(21) Appl. No.: 17/788,173

(22) PCT Filed: Dec. 22, 2020
(86) PCT No.: PCT/EP2020/087593

§ 371 Date: Jun. 22, 2022

(30) Foreign Application Priority Data
Dec. 23, 2019 (FR) FR1915467

(51) Int. Cl. B66F 11/04; B66F 17/00

(52) U.S. Cl. CPC B66F 11/042; B66F 17/006

(57) ABSTRACT

The scissor lift platform includes a frame resting on the ground by connecting members, a platform, a device for lifting the platform, including a set of jointed bars supporting the platform, so the elevation of the platform relative to the frame is variable and controlled by the set of bars, the set of bars including four lower bars defining parallel pairs hinged to four lower articulation blocks connected to the frame, the set of bars also including four upper bars defining parallel pairs hinged to four upper articulation blocks connected to the platform, and at least four sensors each measuring a reaction force, the sensors each having a lower or upper articulation block. Each articulation block/sensor includes first and a second portions. Each sensor is positioned between the first portion of the articulation block in which the sensor is mounted and the second portion of the articulation block.

This application is the U.S. national phase of International Application No. PCT/EP2020/087593 filed Dec. 22, 2020, which designated the U.S. and claims priority to FR 1915467 filed Dec. 23, 2019, the entire contents of each of which are hereby incorporated by reference.

### BACKGROUND OF THE INVENTION

### Field of the Invention

The present invention relates to a scissor lift cradle and a method for determining the stability of such a cradle.

### Description of the Related Art

Scissor lift cradles include a frame mounted on wheels, a lifting device in the form of articulated arms in scissor form, and a work platform configured to be lifted owing to the lifting device. The lifting of the platform is generally done by means of a jack actuating the articulated arms. The scissor arms are articulated to one another by axles. To allow lifting, the ends of the upper arms are connected to pads intended to slide in rails provided below the floor of the platform. The ends of the lower arms are connected to pads intended to slide in rails provided on the frame.

On scissor cradles, stability is essential for safety reasons. The height of the platform, as well as the load that it bears, must be known to control this stability and to ensure that the operator does not use the machine beyond safe conditions.

EP 1,396,468 describes shear stress sensors that are integrated into the pivot pins of the arms relative to the pads. Such a technique requires specially designed pivot pins.

### SUMMARY OF THE INVENTION

The invention aims to address these drawbacks by proposing a new scissor lift cradle, in which the stability can be measured by using lower-cost sensors and with a simplified design.

To this end, the invention relates to a scissor lift cradle comprising:

a frame able to rest on the ground by connecting members,

a platform,

a device for lifting the platform, comprising a set of jointed bars supporting the platform, such that the elevation of the platform relative to the frame is variable and controlled by the set of jointed bars, the set of jointed bars comprising four lower bars defining parallel pairs hinged to four lower articulation blocks connected to the frame, the set of jointed bars also comprising four upper bars defining parallel pairs hinged to four upper articulation blocks connected to the platform,

at least four sensors each configured to measure a reaction force induced by the platform in one of the four lower articulation blocks and/or in one of the four upper articulation blocks along a vertical axis of the scissor lift cradle, these sensors each equipping a lower or upper articulation block, wherein each articulation block provided with a sensor comprises a first portion secured to a pivot axis hinged to one of the lower or upper bars, respectively, and a second portion which is movable relative to the first portion and in contact with a surface of the frame or the platform, respectively, and wherein each sensor is inserted between the first portion and the second portion of the articulation block in which the sensor is mounted so as to measure a force exerted by the second portion on the first portion corresponding to the reaction force. Owing to the invention, it is possible to define the stability of the machine by using standard stress sensors.

According to advantageous, but optional features of the cradle according to the invention:

in each articulation block equipped with a sensor, the first portion of the articulation block comprises a surface perpendicular to the vertical axis, and the second portion of the articulation block comprises a surface perpendicular to the vertical axis and opposite the surface of the first portion, the first portion and the second portion being translatable relative to one another along the vertical axis, and the sensor is a compression sensor and is inserted between the surface of the first portion and the surface of the second portion.

the second portion of each articulation block equipped with a sensor respectively forms an upper or lower zone of the articulation block, and is inserted into an upper or lower housing formed on the first portion of the articulation block.

the second portion has a recess in which the first portion is inserted.

the first portion includes a vertical rod secured to the pivot axis and perpendicular to this axis, the vertical rod has a ring forming the surface of the first portion, the vertical rod passes through the second portion around the surface of the second portion, and the compression sensor has an annular shape and rests between the ring of the vertical rod and the surface of the second portion.

at least two of the lower articulation blocks, hinged on two parallel lower bars, are slidingly connected to the frame by a pad which is provided on the second portion of the at least two of the lower articulation blocks and which is bearing against a surface of a rail attached to the frame, and at least two of the upper articulation blocks, hinged on two parallel upper bars, are slidingly connected to the platform by a pad which is provided on the second portion of the at least two of the upper articulation blocks and which is bearing against a surface of a rail attached to the platform.

the at least four sensors are provided in the lower articulation blocks.

the at least four sensors are provided in the upper articulation blocks.

the platform includes a retractable extension, which is configured to be deployed on one side of the platform so as to increase the surface of the platform, the sensor equipping each of the four upper articulation blocks is mounted floating in a housing of the first portion, each upper articulation block comprises two movable portions relative to the first portion, each of these two movable portions respectively being in contact with an upper and lower surface of a rail attached to the platform and in which the upper articulation block is mounted, and each of the two movable portions is in contact with the sensor.

the platform includes a retractable extension, which is configured to be deployed on one side of the platform so as to increase the surface of the platform, each upper articulation block comprises two movable portions relative to the first portion, each of these two movable portions respectively being in contact with an upper and lower surface of a rail attached to the platform and in which the upper articulation block is mounted, and the upper articulation block is equipped with two sensors, one being configured to measure the force exerted on the first portion by the movable portion in contact with the upper surface of the rail, the other being configured to measure the force exerted on the first portion by the movable portion in contact with the lower surface of the rail.

The invention also relates to a method for determining the stability of a cradle as mentioned above, this method comprising a step consisting, in an electronic unit of the cradle, in calculating the sum of two of the reaction forces induced by the platform in one of the four lower articulation blocks or of two of the reaction forces induced by the platform in one of the four upper articulation blocks, and comparing said sum to a threshold value, and if said sum is below the threshold value, in triggering actions limiting tipping risk.

According to advantageous, but optional features of the method according to the invention:

the actions limiting tipping risk comprise at least activating an alarm or blocking movements of the scissor lift cradle in a direction corresponding to the reaction forces whose sum is lower than the threshold value.

the method comprises a step consisting in calculating, in the electronic unit, the location of a center of gravity of the scissor lift cradle by using the values of the reaction forces induced by the platform in one of the four lower articulation blocks or of the reaction forces induced by the platform in one of the four upper articulation blocks, and as a function of the position of the center of gravity relative to a stability envelope in a horizontal plane defined by the frame, authorizing or blocking movements of the scissor lift cradle.

### BRIEF DESCRIPTION OF THE DRAWINGS

The invention will be better understood, and other advantages thereof will appear more clearly, in light of the following description of a scissor lift cradle and a method for determining stability according to its principle, provided as a non-limiting example in reference to the appended drawings, in which:

FIG. 1 is a perspective view of a scissor lift cradle according to the invention;

FIG. 2 is a side view of a frame of the cradle of FIG. 1;

FIG. 3 is a side view of a platform of the cradle of FIG. 1;

FIG. 4 is a sectional view of a lower articulation block of the lift cradle equipped with a force sensor;

FIG. 5 is a perspective view of the articulation block of FIG. 4;

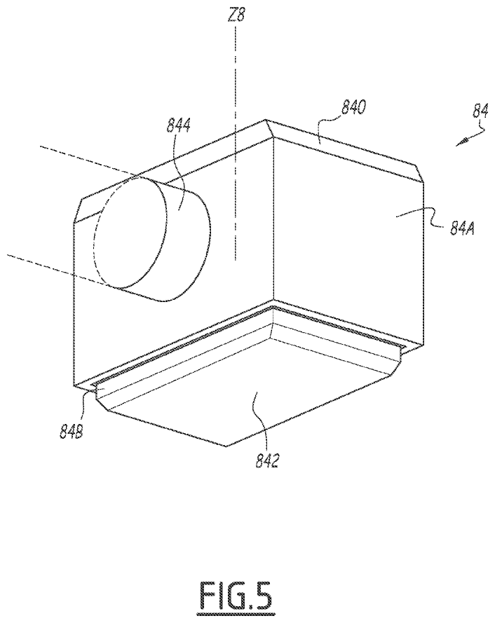

FIG. 6 is a sectional view of an upper articulation block equipped with a force sensor, belonging to a lift cradle according to a second embodiment of the invention;

FIG. 7 is an exploded perspective view of an upper articulation block equipped with a force sensor, belonging to a lift cradle according to a third embodiment of the invention;

FIG. 8 is a cross-section of an upper articulation block equipped with a sensor, belonging to a lift cradle according to a fourth embodiment of the invention;

FIG. 9 is a side view of a platform of a lift cradle according to a fifth embodiment of the invention, comprising a deployed lateral extension;

FIG. 10 is a cross-section of an upper articulation block of the platform of FIG. 9, equipped with a floating sensor;

FIG. 11 is a cross-section of an upper articulation block equipped with two sensors, belonging to a platform similar to FIG. 9, and belonging to a lift cradle according to a sixth embodiment of the invention.

### DESCRIPTION OF THE PREFERRED EMBODIMENTS

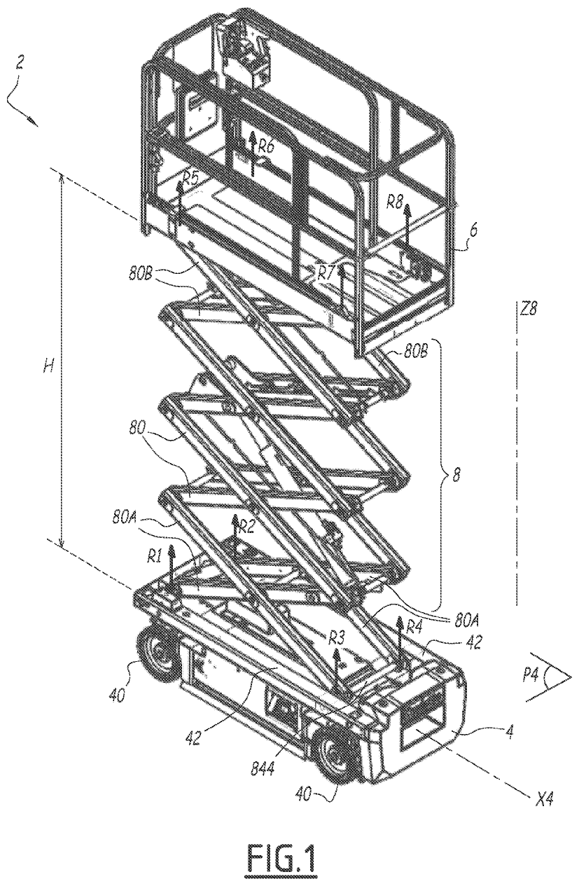

FIG. 1 shows a scissor lift cradle 2, comprising a frame 4 able to rest on the ground S by connecting members such as wheels 40. The cradle 2 also comprises a platform 6, and a device for lifting 8 the platform 6. The lifting device 8 comprises a set of jointed bars 80 supporting the platform 6, such that the elevation of the platform 6 relative to the frame 4 is variable and controlled by the set of bars 80. The lifting device 8 also comprises a jack 82 that actuates the bars 80 in order to control the height H of the platform 6 relative to the frame 4.

The frame 4 defines a horizontal plane P4. The lifting device 8 defines a vertical elevation axis Z8 perpendicular to the horizontal plane P4. Reference X4 designates a longitudinal axis of the frame 4 oriented parallel to the direction of advance of the frame 4. The longitudinal axis X4 is parallel to the horizontal plane P4 and perpendicular to the vertical axis Z8.

The set of bars 80 comprising four lower bars 80A defining parallel pairs connected to the frame 4 by four lower articulation blocks 84, three of which are visible in FIG. 1. The set of bars 80 also comprising four upper bars 80B defining parallel pairs connected to the platform 6 by four upper articulation blocks 86.

The frame 4 is equipped with two rails 42, arranged parallel to the longitudinal axis X4 on each longitudinal side on an upper portion of the frame 4. Each of these rails 42 is used to connect two of the lower articulation blocks 84 to the frame 4.

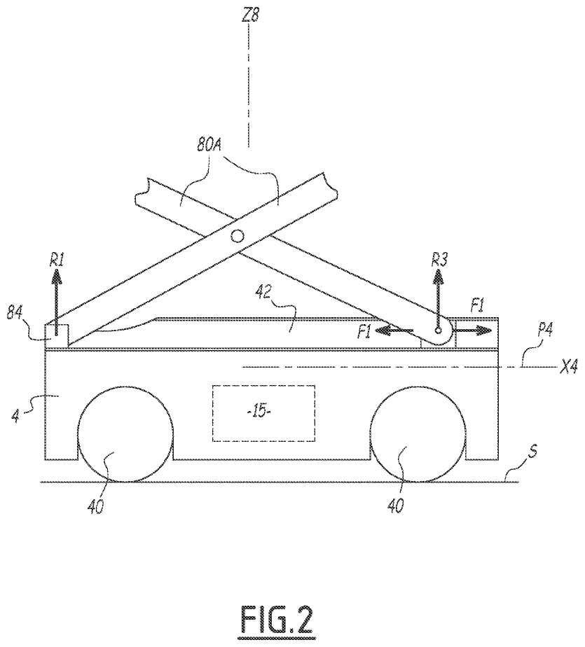

One of the rails 42 is visible in FIG. 2. The lower articulation block 84 located on the left side of the rail 42 is mounted fixedly to the rail 42. The lower articulation block 84 located on the right side is mounted slidingly in the rail 42, so as to be free in translation along the longitudinal axis X4 along the arrows F1. Two of the lower parallel bars 80A are therefore slidingly connected to the frame 4.

Likewise, the platform 6 is equipped with two rails 62, arranged parallel to the longitudinal axis X4 on each longitudinal side on an upper portion of the frame 6. Each of these rails 62 is used to connect two of the upper articulation blocks 86 to the platform 6.

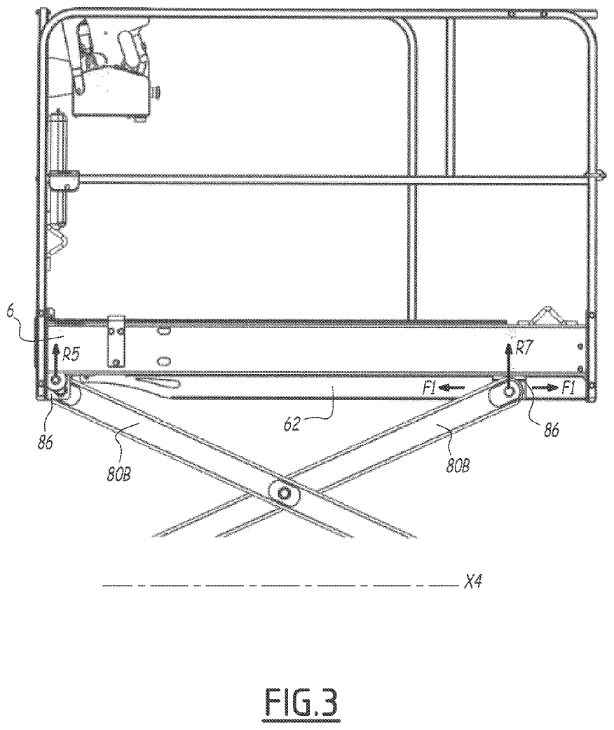

One of the rails 62 is visible in FIG. 3. The upper articulation block 86 located on the left side of the rail 62 is mounted fixedly to the rail 62. The upper articulation block 86 located on the right side is mounted slidingly in the rail 62, so as to be free in translation along the longitudinal axis X4 along the arrows F1. Two of the upper parallel bars 80B are therefore slidingly connected to the platform 6.

The sliding of the articulation blocks 84 and 86 in the rails 42 and 62 allows the rotation of the bars of the set of bars 80 and allows the elevation or the lowering of the platform 6 along the vertical axis Z8.

In a variant that is not shown, the four upper articulation blocks 86 and the four lower articulation blocks 84 can be mounted sliding respectively relative to the platform 6 and the frame 4.

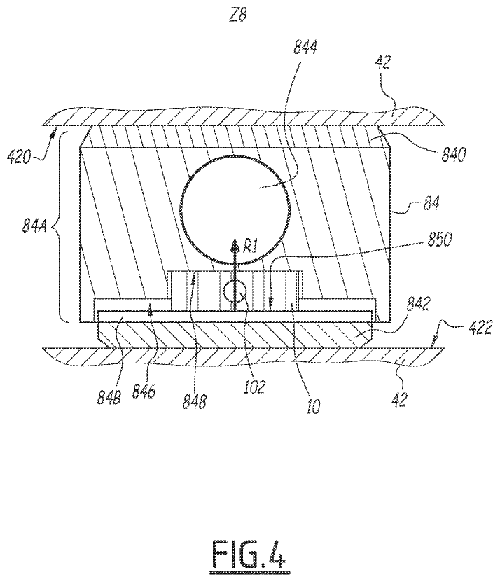

FIG. 4 shows an enlarged sectional view of the structure of one of the lower articulation blocks 84 mounted in one of the rails 42 of the frame 4. The rail 42 includes an upper surface 420 oriented downward, and which exerts sliding contact on an upper pad 840 borne by the articulation block 84. The rail 42 also includes a lower surface 422, oriented upward, opposite the upper surface 420, and which exerts a sliding contact on a lower pad 842 of the upper articulation block 84.

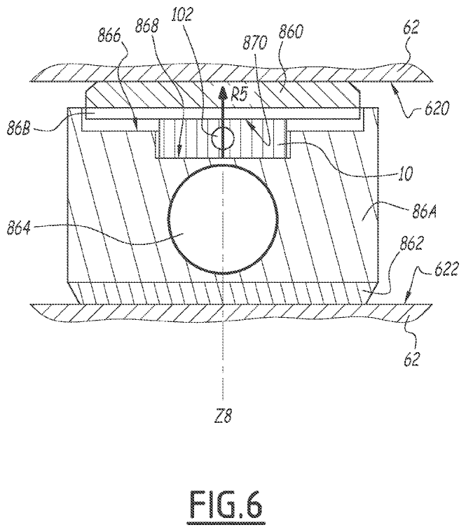

The upper articulation blocks 86 have a similar structure. FIG. 6 shows an enlarged sectional view of the structure of one of the upper articulation blocks 86 mounted in one of the rails 62 of the platform 6. The rail 62 includes an upper surface 620 oriented downward, and which exerts sliding contact on an upper pad 860 borne by the articulation block 86. The rail 62 also includes a lower surface 622, oriented upward, opposite the upper surface 620, and which exerts a sliding contact on a lower pad 862 of the upper articulation block 86.

To evaluate the stability of the lift cradle 2, the latter comprises at least four sensors 10 that are configured to measure reaction forces induced by the platform 6, any load thereof and the lifting device 8 on the lower articulation blocks 84 along the vertical axis Z8. According to a first embodiment, the lift cradle 2 includes four sensors 10 that each equip lower articulation blocks 84.

Each articulation block 84 includes a first portion 84A, secured to an axle 844 hinged on the lower bars 80A, and a second portion 84B, movable relative to the first portion 84A and which is in contact with a surface of the frame 4. The sensors 10 are inserted between the first portion 84A and the second portion 84B.

More specifically, the first portion 84A bears the upper pad 840, while the second portion 84B bears the lower pad 842. The axle 844 is attached to the first portion 84A, and one of the lower bars 80A is mounted rotating on the axle 844.

The second portion 84B of each lower articulation block 84 equipped with a sensor 10 is formed by a body forming a lower zone of the lower articulation block 84, and is inserted into a lower housing 846 formed on the first portion 84A.

The first portion 84A of the lower articulation block 84 comprises a surface 848 perpendicular to the vertical axis Z8, the second portion 84B comprises a surface 850 perpendicular to the vertical axis Z8 and opposite the surface 848 of the first portion 84A. The sensor 10 is a compression sensor inserted between the surface 848 of the first portion 84A and the surface 850 of the second portion 84B. The first portion 84A and the second portion 84B are translatable relative to one another along the vertical axis Z8. The weight of the platform 6 and any load thereof, added to the weight of the lifting device 8, exerts a force oriented vertically downward, which induces a reaction force R1 oriented upward and which is exerted by the resistance of the second portion 84B, bearing against the frame 4, against the force exerted by the first portion 84A. The reaction force R1 induces a compression in the sensor 10, compressed between the surfaces 848 and 850 parallel to the vertical axis Z8, which allows the value of the corresponding force to be measured.

The compression sensor 10 is a standard component of annular shape having, in its center, a contact 100 for measuring force, and at its periphery, a cable outlet 102 for transmitting measurements. The structure of the lower articulation block 84 allows integration of standard components, which allows a reduction in the cost of the machine and easier maintenance in case of defective operation of a sensor 10.

The reaction forces measured by the sensors 10 in the four lower articulation blocks 84 are respectively referenced R1, R2, R3 and R4.

The scissor lift cradle 2 includes an electronic unit 15 for calculating stability and controlling the lift cradle 2. This electronic unit is configured to perform different stability calculations.

The values of the reactions R1, R2, R3 and R4 allow determination of the inclination, that is to say, the angle of incline of the plane P4 of the frame relative to the ground S. In FIG. 2, the plane P4 is parallel to the ground S; the inclination is therefore zero. However, on uneven ground S, the plane P4 cannot be parallel to the ground S, and an angle of inclination then exists. The lifting device 8 is therefore tilted, which requires evaluating the stability of the cradle 2.

When the sum of two of the values R1, R2, R3 and R4 becomes less than a threshold value, this means that on the side of the articulation blocks 84 concerned, the reaction has become too low and the inclination is causing most of the weight to be carried on the other two articulation blocks 84, which increases the risk of tipping. Taking account of the elevation of the platform and the total mass of the cradle 2, the electronic unit 15 calculates whether the movements in the concerned direction must be monitored, determines the tipping tendency, and can activate an alarm and block the potentially aggravating movements.

By using the values of the reactions R1, R2, R3 and R4 and the weight of the cradle, the electronic unit 15 locates the center of gravity of the cradle 2. The stability is verified relative to a stability envelope defined in the plane P4. This envelope can take the form of a rectangle, a circle, an ellipse, more generally any shape suitable for the characteristics of the lift cradle 2.

If the center of gravity is located in the stability envelope, the elevation of the platform 6 relative to the frame 4 and the movements of the frame 4 relative to the ground S within the limits of this envelope are authorized by the electronic unit 15. Conversely, if a movement tends to depart from the center of gravity of the stability envelope, this movement is prohibited by the electronic unit 15.

A movement that improves the stability, that is to say, that resituates the center of gravity in a better zone of the stability envelope, is authorized by the electronic unit 15.

The invention therefore allows tipping prediction and control of the lift cradle 2 more efficiently than in the prior art techniques. In fact, the calculation and location of the center of gravity of the load of the platform 6 allows precise determination of the tipping tendency in case of inclination and adaptation of the movement possibilities of the machine.

In the known prior art, if the inclination measured by a suitable sensor exceeds a maximum value, the vehicle control system stops all movements. The invention allows the movements of the cradle to be limited differently, and not to systematically prohibit all movements when some are beneficial for stability.

The invention is particularly advantageous in the case of machines intended for use in interior spaces, in which the ground is generally always flat, and which may be used outside on an exceptional basis, where the ground may be uneven. These machines are not equipped with a sensor to detect whether the machine is outside or inside, which does not allow the behavior of the machine to be adapted and makes outdoor use thereof dangerous. With the calculation of the center of gravity, if an indoor machine is used outside, tipping risks may still be detected.

In the case where the sensors 10 are mounted in the lower articulation blocks 84, that is to say, on the side of the frame 4, the determination of the tipping tendency is more precise, since forces from the wind on the lifting device 8 and the platform 6 are reflected by the measurements of the reactions R1, R2, R3 and R4 and are therefore taken into account in their impact on tipping, which allows improved performance and control of the machine.

Other embodiments of the invention are shown in FIGS. 6 to 11. In these embodiments, the elements shared with the first embodiment bear the same references and operate in the same manner. Only the differences are outlined below.

FIG. 6 shows a second embodiment, in which the four sensors 10 equip the upper articulation blocks 86. In this case, the operating principle of the sensors 10 and their installation in the upper articulation blocks 86 follow the same principle as that of the lower articulation blocks 84, with an inverted structure.

The upper articulation blocks 86 include a first portion 86A, which is secured to an axle 864 hinged on the upper bars 80B, and a second portion 86B, translatable relative to the first portion 86A along the vertical axis Z8, and which is in contact with a surface of the platform 6, in the case at hand the lower surface 620, by means of the pad 860. The first portion 86A is in contact with the rail 62 via the lower pad 862.

In this scenario, the second portion 86B forms the upper portion of the articulation block 86, and the first portion 86A has a housing 866 formed on its upper portion, in which the second portion 86B is received. The first portion 86A has a surface 868 perpendicular to the vertical axis Z8, and the second portion 86B has a surface 870 perpendicular to the vertical axis Z8 and opposite the surface 866. The sensor 10 is compressed between the surfaces 866 and 870, and allows measurement of a reaction force R5 of the lifting device 8 induced by the weight of the platform 6 and any load thereof.

The reaction forces measured by the sensors 10 in the four upper articulation blocks 86 are respectively referenced R5, R6, R7 and R8.

Measuring the reaction forces R5, R6, R7 and R8 allows calculation, with the electronic unit 15, of the location of the center of gravity of the platform 6 and of a load located therein, and therefore measurement of the influence of the inclination on the stability of the lift cradle 2.

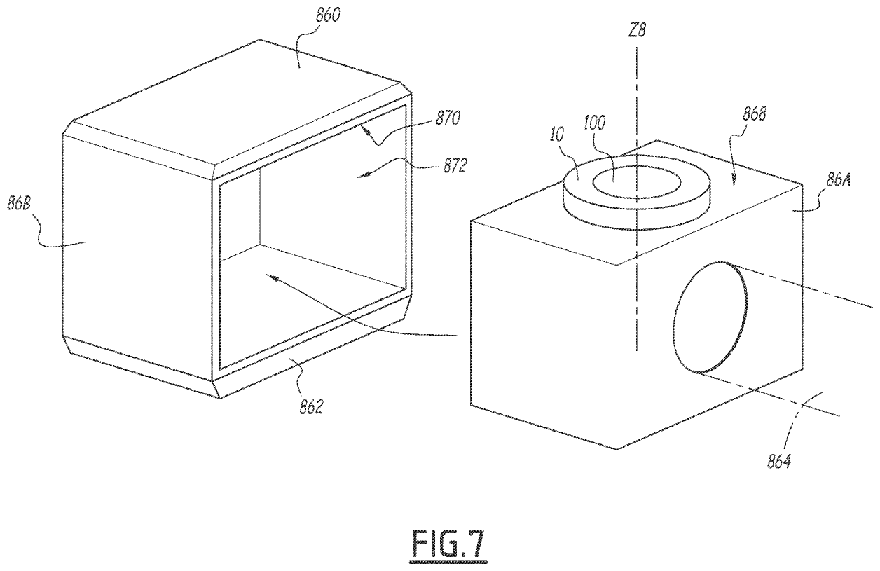

FIG. 7 shows a third embodiment, applied to one of the upper articulation blocks 86, but which is also applicable to the lower articulation blocks 84. In this embodiment, the second portion 86B assumes the form of a hollow body having a recess 872 in which the first portion 86A is inserted. The second portion 86B in this case bears both the upper pad 860 and the lower pad 862. The first portion 86A then assumes the form of a parallelepipedal body secured to the axle 864. The surface 870 is formed by an upper inner face of the cavity 872, and the surface 868 is formed by the upper face of the parallelepiped forming the first portion 86A. The respective dimensions of the cavity 872 and of the first portion 86A allow a relative translational movement along the vertical axis Z8 such that the variations in the compression of the sensor 10, compressed between the surfaces 868 and 870, allow measurement of the reaction force.

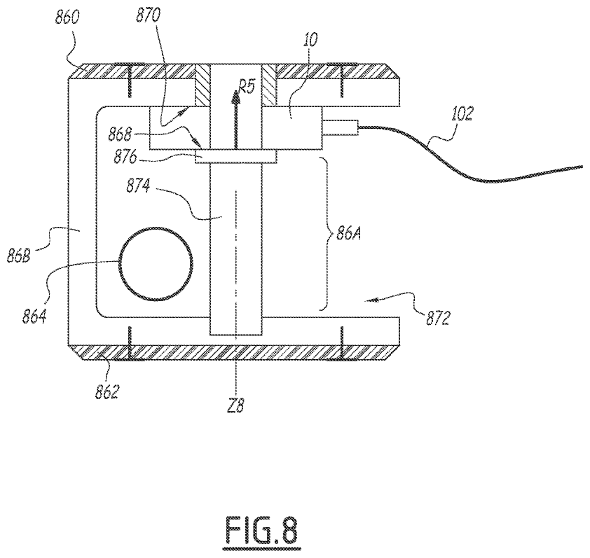

FIG. 8 shows a fourth embodiment, applied to one of the upper articulation blocks 86, but which is also applicable to the lower articulation blocks 84. In this embodiment, the first portion 86A includes a vertical rod 874 centered on the vertical axis Z8, secured to the axle 864 and perpendicular to this axle 864, which is placed off-centered relative to the vertical axis Z8. The vertical rod 874 has a ring 876 on which the surface 868 of the first portion 86A is formed.

The second portion 86B has a shape similar to that of FIG. 7 with a recess 872 on which the surface 870 is formed. The vertical rod 874 passes through the second portion 86B around the surface 870, and the compression sensor 10, which in this case is annular, is compressed between the ring 876 and the surface 870 of the second portion 86B.

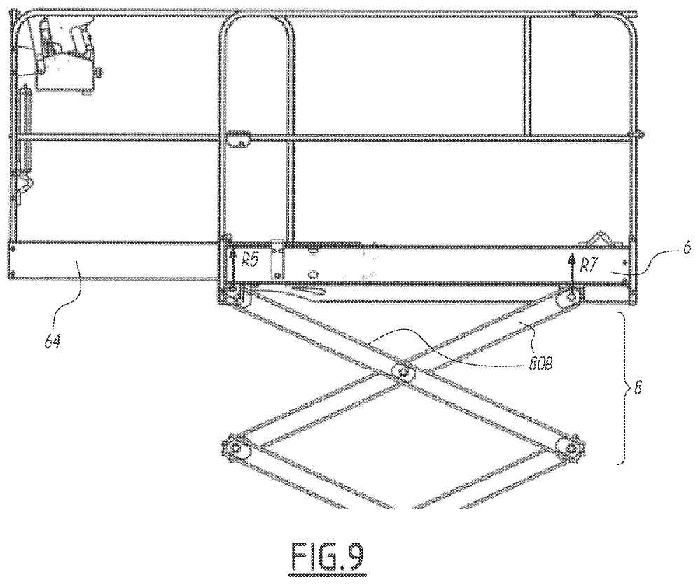

FIGS. 9, 10 and 11 show a fifth and a sixth embodiment of the invention. According to an optional aspect shown in FIG. 9, the platform 6 includes a retractable extension 64, which is configured to be deployed on one side of the platform 6 so as to increase the surface thereof. The deployment of the extension 64 modifies the location of the center of gravity of the platform 6.

In the case where the sensors 10 equip the lower articulation blocks 84, the deployment of the extension 64 will be taken into account in analyzing the stability and the measurements from the sensors 10 will give reaction forces R1, R2, R3 and R4 modified by the deployment of the extension 64.

Conversely, in the case where the sensors 10 equip the upper articulation blocks 86, the deployed extension 64 accentuates the weight exerted on the articulation blocks 86 closest to the extension 64, and decreases the weight exerted on the articulation blocks 86 furthest from the extension 64, in a cantilever phenomenon, which may cause erroneous measurements of the reaction forces R7 and R8, located opposite the extension 64, in the case where no further compression is exerted on the sensors 10.

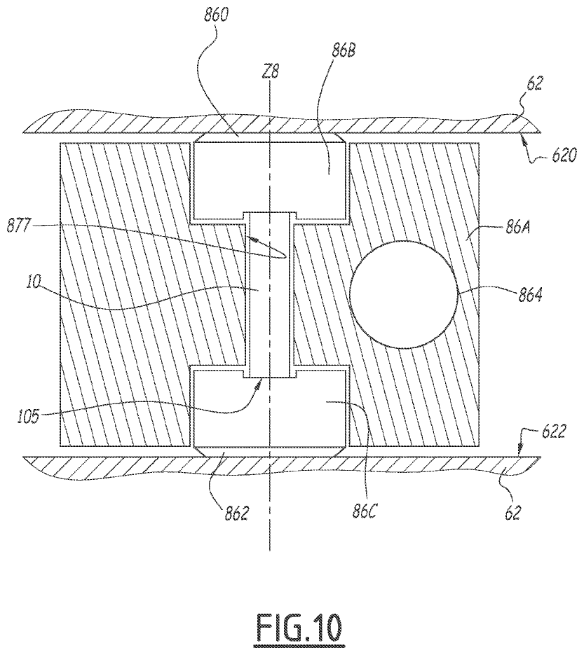

In such a case, as is visible in FIG. 10 showing the fifth embodiment, the sensor 10 equipping each of the four upper articulation blocks 86 has a cylindrical shape centered on the vertical axis Z8 and is mounted floating in a cylindrical housing 877 of the first portion 86A, that is to say, it is freely translatable along the vertical axis Z8, relative to the first portion 86A.

The upper articulation block 86 comprises two portions 86B and 86C that are movable relative to the first portion 86A along the vertical axis Z8. The movable portion 86B is in contact with the upper surface 620 of the rail 62 and bears the upper pad 860, while the movable portion 86C is in contact with the lower surface 622 of the rail 62. Lastly, each of the two movable portions 86B and 86C is in contact with a respective axial end 104 and 105 of the sensor 10.

Thus, when the extension 64 is retracted, the reaction force along the vertical axis Z8 will be measured by the transmission of the weight of the platform 6 to the movable portion 86B. The movable portion 86B moves the sensor 10 against the shoulder 8770, which exerts the reaction force of the lifting device 8, and the compression of the sensor 10 allows measurement of the reaction force.

In the case where the extension 64 is deployed, the side of the platform 6 opposite the extension 64 will tend to be raised and to exert a force oriented upward on the first portion 86A. The weight of the platform 6 is then transmitted by the movable portion 86C, which moves the sensor against the shoulder 8772, and the measurement of the reaction force therefore corresponds to the compression of the sensor 10 between the shoulder 8772 and the movable portion 86C.

In this scenario, the pivot pin 864 is in the off-centered position relative to the vertical axis Z8.

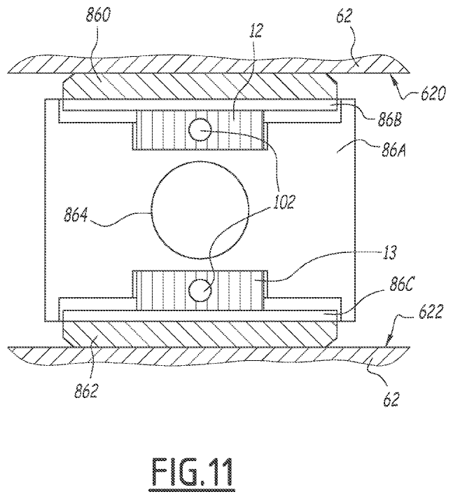

According to a sixth embodiment shown in FIG. 11, instead of a single floating sensor 10, the upper articulation block 86 is equipped with two sensors 12 and 13, positioned fixedly in the first portion 86A. The sensor 12 is located above the axle 864 and is configured to measure the force exerted on the first portion 86A by the movable portion 86B in contact with the upper surface 620 of the rail 62. The sensor 13 is located below the axle 864 and is configured to measure the force exerted on the first portion 86A by the movable portion 86C in contact with the lower surface 622 of the rail 62.

According to a variant of the invention that is not shown, the sensors 10 may not be compression sensors, but strain sensors, and the lift cradle may comprise a data processing system configured to calculate the reaction forces from strain measurements.

The features of the embodiments and variants described above may be combined to form other embodiments within the scope defined by the claims.

1. Scissor lift cradle comprising:
a frame able to rest on the ground by connecting members,
a platform,
a device for lifting the platform, comprising a set of jointed bars supporting the platform, such that the elevation of the platform relative to the frame is variable and controlled by the set of jointed bars, the set of jointed bars comprising four lower bars defining parallel pairs hinged to four lower articulation blocks connected to the frame, the set of jointed bars also comprising four upper bars defining parallel pairs hinged to four upper articulation blocks connected to the platform,
at least four sensors each configured to measure a reaction force induced by the platform in one of the four lower articulation blocks and/or in one of the four upper articulation blocks along a vertical axis of the scissor lift cradle, these sensors each equipping a lower or upper articulation block,
wherein each articulation block provided with a sensor comprises a first portion secured to a pivot axis hinged to one of the lower or upper bars, respectively, and a second portion which is movable relative to the first portion and in contact with a surface of the frame or the platform, respectively, and wherein each sensor is inserted between the first portion and the second portion of the articulation block in which the sensor is mounted so as to measure a force exerted by the second portion on the first portion corresponding to the reaction force.

2. The scissor lift cradle according to claim 1, wherein in each articulation block equipped with a sensor, the first portion of the articulation block comprises a surface perpendicular to the vertical axis, and the second portion of the articulation block comprises a surface perpendicular to the vertical axis and opposite the surface of the first portion, the first portion and the second portion being translatable relative to one another along the vertical axis, and wherein the sensor is a compression sensor and is inserted between the surface of the first portion and the surface of the second portion.

3. The scissor lift cradle according to claim 2, wherein the second portion of each articulation block equipped with a sensor respectively forms an upper or lower zone of the articulation block, and is inserted into an upper or lower housing formed on the first portion of the articulation block.

4. The scissor lift cradle according to claim 2, characterized in wherein the second portion has a recessin which the first portion is inserted.

5. The scissor lift cradle according to claim 2, characterized in wherein the first portion includes a vertical rodsecured to the pivot axisand perpendicular to this axis, wherein the vertical rod has a ring forming the surface of the first portion, wherein the vertical rod passes through the second portion around the surface of the second portion, and wherein the compression sensor has an annular shape and rests between the ring of the vertical rod and the surface of the second portion.

6. The scissor lift cradle according to claim 1, wherein at least two of the lower articulation blocks, hinged on two parallel lower bars, are slidingly connected to the frame by a pad which is provided on the second portion of the at least two of the lower articulation blocks and which is bearing against a surface of a rail attached to the frame, and wherein at least two of the upper articulation blocks, hinged on two parallel upper bars, are slidingly connected to the platform by a pad which is provided on the second portion of the at least two of the upper articulation blocks and which is bearing against a surface of a rail attached to the platform.

7. The scissor lift platform according to claim 1, wherein the at least four sensors are provided in the lower articulation blocks.

8. The scissor lift platform according to claim 1, wherein the at least four sensors are provided in the upper articulation blocks.

9. The scissor lift platform according to claim 8, wherein the platform includes a retractable extension, which is configured to be deployed on one side of the platform so as to increase the surface of the platform, wherein the sensor equipping each of the four upper articulation blocks is mounted floating in a housing of the first portion, wherein each upper articulation block comprises two movable portions relative to the first portion, each of these two movable portions respectively being in contact with an upper and lower surface of a rail attached to the platform and in which the upper articulation block is mounted, and wherein each of the two movable portions is in contact with the sensor.

10. The scissor lift platform according to claim 8, wherein the platform includes a retractable extension, which is configured to be deployed on one side of the platform so as to increase the surface of the platform, wherein each upper articulation block comprises two movable portions relative to the first portion, each of these two movable portions respectively being in contact with an upper and lowers surface of a rail attached to the platform and in which the upper articulation block is mounted, and wherein the upper articulation block is equipped with two sensors, one being configured to measure the force exerted on the first portion by the movable portion in contact with the upper surface of the rail, the other being configured to measure the force exerted on the first portion by the movable portion in contact with the lower surface of the rail.

11. A method for determining the stability of the scissor lift cradle according to claim 1, wherein the method comprises a step consisting, in an electronic unit of the cradle, in calculating the sum of two of the reaction forces induced by the platform in one of the four lower articulation blocks or of two of the reaction forces induced by the platform in one of the four upper articulation blocks, and comparing said sum to a threshold value, and if said sum is below the threshold value, in triggering actions limiting tipping risk.

12. The method according to claim 11, wherein the actions limiting tipping risk comprise at least activating an alarm or blocking movements of the scissor lift cradle in a direction corresponding to the reaction forces whose sum is lower than the threshold value.

13. The method according to claim 11, wherein the method comprises a step consisting in calculating, in the electronic unit, the location of a center of gravity of the scissor lift cradle by using the values of the reaction forces induced by the platform in one of the four lower articulation blocks or of the reaction forces induced by the platform in one of the four upper articulation blocks, and as a function of the position of the center of gravity relative to a stability envelope in a horizontal plane defined by the frame, authorizing or blocking movements of the scissor lift cradle.

14. The scissor lift cradle according to claim 2, wherein at least two of the lower articulation blocks, hinged on two parallel lower bars, are slidingly connected to the frame by a pad which is provided on the second portion of the at least two of the lower articulation blocks and which is bearing against a surface of a rail attached to the frame, and wherein at least two of the upper articulation blocks, hinged on two parallel upper bars, are slidingly connected to the platform by a pad which is provided on the second portion of the at least two of the upper articulation blocks and which is bearing against a surface of a rail attached to the platform.

15. The scissor lift cradle according to claim 3, wherein at least two of the lower articulation blocks, hinged on two parallel lower bars, are slidingly connected to the frame by a pad which is provided on the second portion of the at least two of the lower articulation blocks and which is bearing against a surface of a rail attached to the frame, and wherein at least two of the upper articulation blocks, hinged on two parallel upper bars, are slidingly connected to the platform by a pad which is provided on the second portion of the at least two of the upper articulation blocks and which is bearing against a surface of a rail attached to the platform.

16. The scissor lift cradle according to claim 4, wherein at least two of the lower articulation blocks, hinged on two parallel lower bars, are slidingly connected to the frame by a pad which is provided on the second portion of the at least two of the lower articulation blocks and which is bearing against a surface of a rail attached to the frame, and wherein at least two of the upper articulation blocks, hinged on two parallel upper bars, are slidingly connected to the platform by a pad which is provided on the second portion of the at least two of the upper articulation blocks and which is bearing against a surface of a rail attached to the platform.

17. The scissor lift cradle according to claim 5, wherein at least two of the lower articulation blocks, hinged on two parallel lower bars, are slidingly connected to the frame by a pad which is provided on the second portion of the at least two of the lower articulation blocks and which is bearing against a surface of a rail attached to the frame, and wherein at least two of the upper articulation blocks, hinged on two parallel upper bars, are slidingly connected to the platform by a pad which is provided on the second portion of the at least two of the upper articulation blocks and which is bearing against a surface of a rail attached to the platform.

18. The scissor lift platform according to claim 2, wherein the at least four sensors are provided in the lower articulation blocks.

19. The scissor lift platform according to claim 3, wherein the at least four sensors are provided in the lower articulation blocks.

20. The scissor lift platform according to claim 4, wherein the at least four sensors are provided in the lower articulation blocks.
